(19) United States
(12) Patent Application Publication
(10) Pub. No.: US 2008/0093436 A1
(43) Pub. Date: Apr. 24, 2008

(54) WASTE/RECYCLING CONTAINER WITH RFID DEVICE

(75) Inventor: Kathleen M. Bolhous, Appleton, WI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: Cascade Engineering, Inc., Grand Rapids, MI (US)

(21) Appl. No.: 11/551,812

(22) Filed: Oct. 23, 2006

(51) Int. Cl. G06F 17/00; G06K 19/06

(52) U.S. Cl. 235/375; 235/492

(57) ABSTRACT

An RFID-enabled waste/recycling container in which an RFID device is enclosed within the lower grab bar. As disclosed, the lower grab bar is extruded to define a cavity, and the RFID device is located within the cavity. The RFID device can be fixedly secured within the lower grab bar using keying, adhesive, or foam fill. The open ends of the lower grab bar are sealed to further protect the device. Also disclosed is a method of retrofitting a non-RFID-enabled container with the RFID-enabled lower grab bar to provide the container with RFID capabilities.

### BACKGROUND OF THE INVENTION

The present invention relates to waste and recycling containers, and more particularly to waste and recycling containers including radio frequency identification (RFID) devices.

With increasing frequency, waste and recycling containers are being equipped with radio frequency identification (RFID) devices. An RFID device enables the container to be uniquely identified or associated with a customer or pick-up address. The RFID device typically is read during emptying of the container by an RFID reader within the equipment for lifting and/or weighing the container. Where charges are based on the weight of the waste (or where rebates, rewards, or other benefits are provided based on the weight of the recyclable materials), the RFID device enables weight information to be accurately associated with a customer or a pick-up address to enable accurate and reliable customer billing.

One way of equipping a plastic waste continaer with an RFID device is to mold the device into the body (e.g. the sidewall) of the container. Unfortunately, this approach has at least two disadvantages. First, the temperatures and pressures associated with injection molding can damage the device during molding of the container. Second, when the device is in the sidewall of the container, the device can be damaged by flexure of the container, for example as might occur when the container is gripped by a lifting mechanism. In either case, the device can become inoperative; and the container therefore becomes unusable. In an effort to address these issues, some prior art approaches first support the RFID device on or within a protecive article, and then mold the article into the container. However, this approach increases the cost of the container, can create a weak spot in the container wall, and does not fully resolve the noted issues.

### SUMMARY OF THE INVENTION

The aforementioned problems are overcome by the present invention wherein an RFID device is incorporatd into the lower grab bar of the waste or recycling container.

In the current embodiment, the RFID device is located within a hollow, nonmetallic lower grab bar. More specifically, the lower grab bar is a hollow plastic extrusion sealed at both ends to enclose the device within the bar. After the device is positioned within the bar, foam or another material can be placed with the bar to cushion and/or protect the device.

In another aspect of the present invention, the RFID lower grab bar enables an existing cart to be RFID-enabled. In this method, 1) the “old” (i.e. non-RFID-enabled) lower grab bar is removed from the container and 2) the “new” (i.e. RFID-enabled) lower grab bar is installed in the container.

The present invention provides an RFID-enabled waste container in which the RFID device is securely protected from damage—both during manufacture of the container and during use of the container. The invention provides an RFID device that is relatively easy to locate and read because of its known position within the lower grab bar. The present invention also enables existing waste containers to become RFID-enabled simply by replacing a non-RFID-enabled lower grab bar with an RFID-enabled lower grab bar.

These and other objects, advantages, and features of the invention will be more fully understood and appreciated by reference to the description of the current embodiment and the drawings.

### BRIEF DESCRIPTION OF THE DRAWINGS

FIG. 1 is a prespective view of a waste cart embodying the present invention;

FIG. 2 is a perspective view of the waste cart container (without the lower grab bar, lid, or wheels);

FIG. 3 is a cross section of the waste cart taken along line 3-3 in FIG. 1;

FIG. 4 is side view of the lower grab bar partially broken to show the RFID device; and

FIG. 5 is an end view of the lower grab bar without the RFID device.

### DESCRIPTION OF THE CURRENT EMBODIMENT

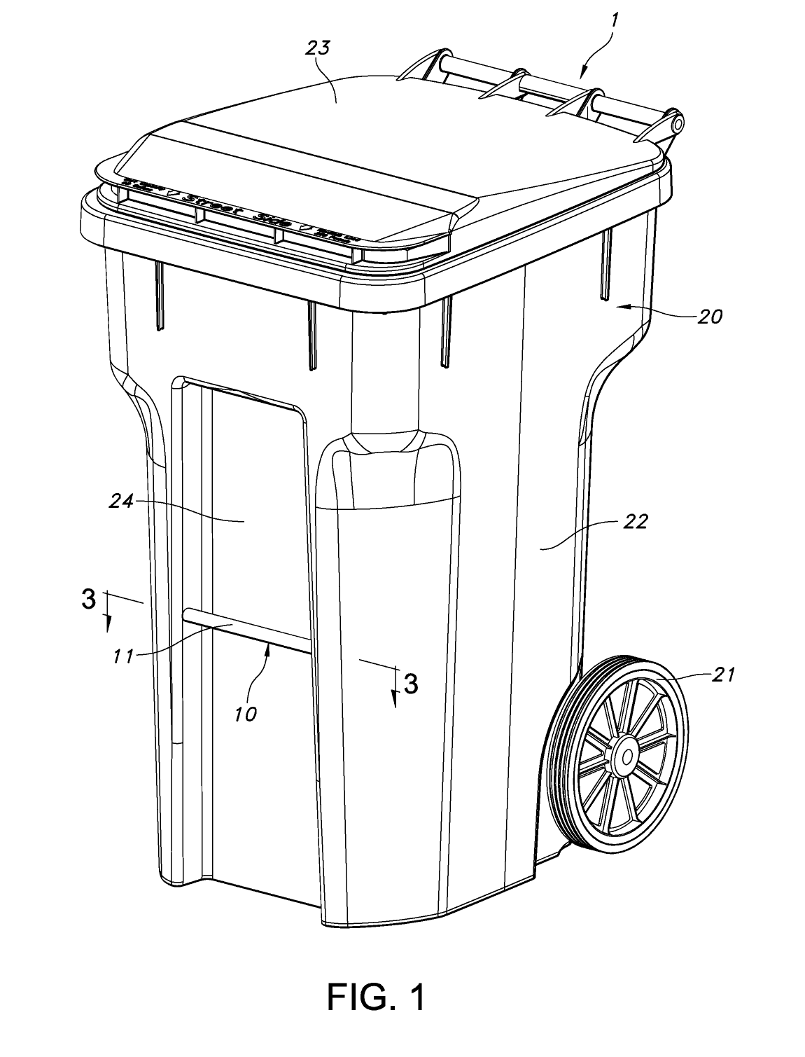

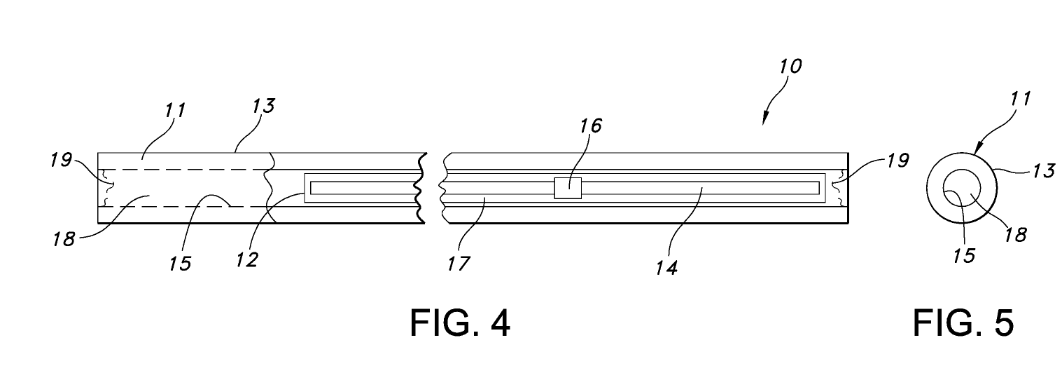

A waste cart constructed in accordance with the current embodiment of the invention is illustrated in FIGS. 1-3 and generally designated 1. The cart includes a lower grab bar assembly 10. As illustrated in FIG. 4, the lower grab bar assembly includes a bar 11 and an RFID device 12. The device is protectively enclosed within the bar. The device 12 can include information uniquely associated with the cart, and the device can be read during emptying and/or weighing of the cart to determine the weight of the cart contents.

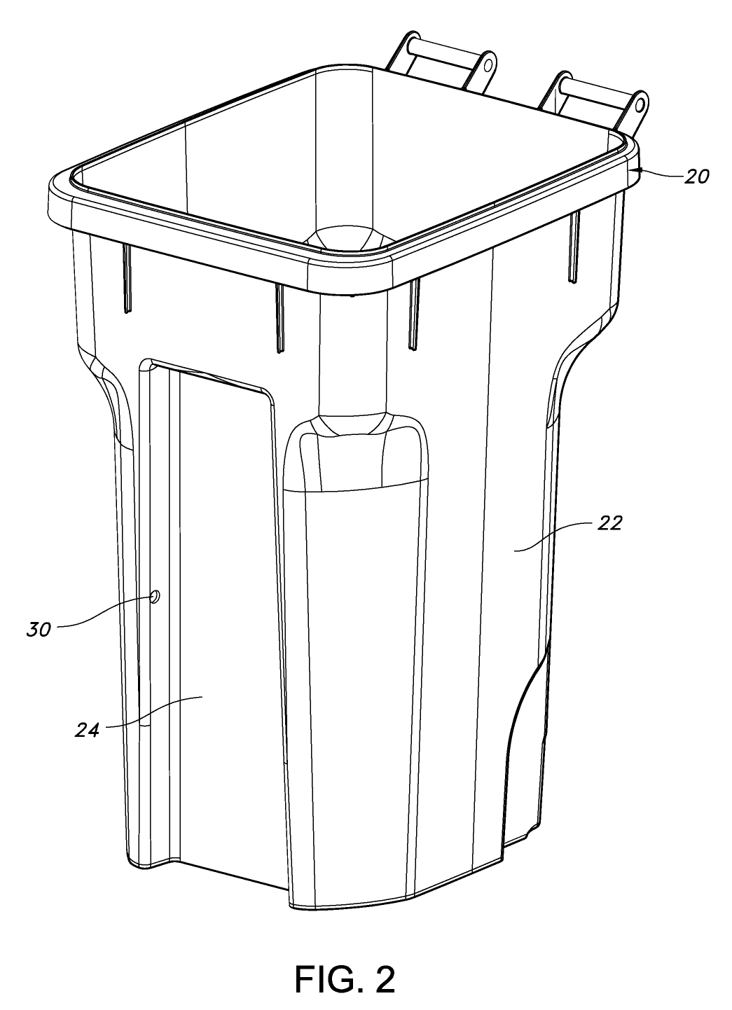

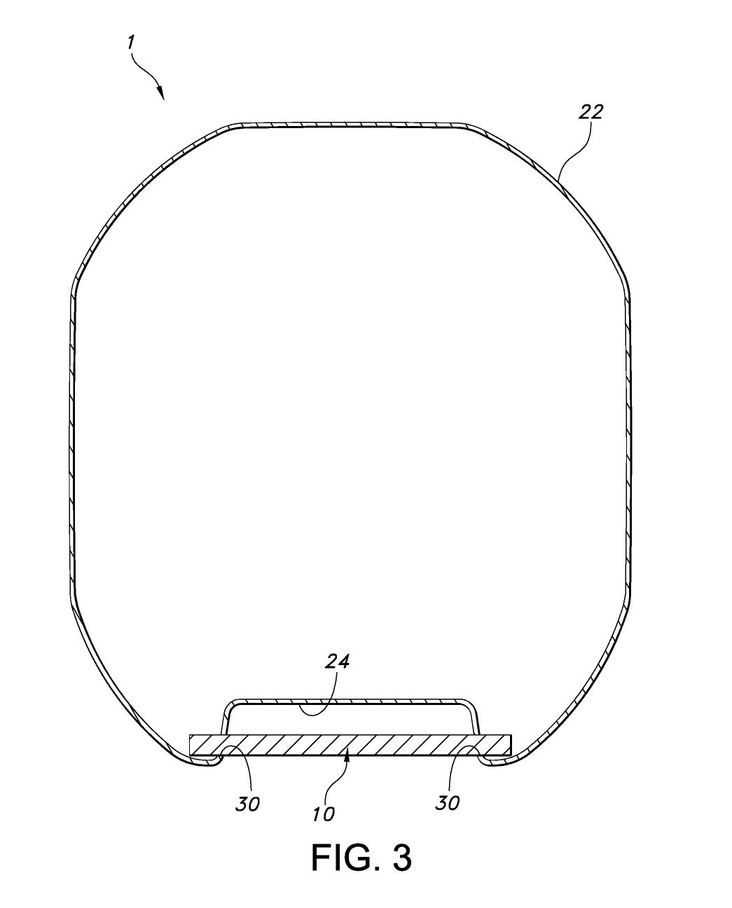

With the exception of the lower grab bar assembly 10, the cart 1 is generally well known to those in the waste cart or container art. The cart includes a container or bin 20 having a sidewall 22. The container 20 is supported on wheels 21 and closed by a hinged lid 23. The container 20 and the lid are injection molded of plastic, but could be formed by rotational molding, vacuum molding, blow molding, or any other suitable technique. The wheels are mounted on an axle (not visible) to enable rolling of the cart. The container defines a recessed lower grab pocket 24 within which the lower grab bar assembly 10 is supported. In prior art containers, the lower grab bar is non-RFID-enabled. As seen in FIGS. 2-3, the pocket defines axially aligned holes or apertures 30 for receiving the lower grab bar assembly. The diameters of the holes 30 are slightly larger than the external diameter of the lower grab bar assembly 10 to closely receive and support the assembly.

As illustrated in FIGS. 4-5, the lower grab bar assembly 10 includes a lower grab bar 11 and an RFID device 12. The current lower grab bar 11 is extruded plastic, having concentric circular outer and inner walls 13 and 15 respectively. The inner wall 15 defines a cavity 18. The lower grab bar 11 may be fabricated of other materials, for example composite or other nonmetallic materials, that do not interfere with the necessary operation of the RFID device 12. Metallic materials may not be suitable because of electrical interference issues. Other manufacturing techniques also could be used. For example, the lower grab bar 11 could be fabricated from solid stock, and the interior of the lower grab bar 11 could be drilled or otherwise hollowed out to form the cavity 18. The cavity 18 may extend along only a portion of the length of the lower grab bar 11. The shape of the lower grab bar 11 also could be varied as appropriate for a particular application.

The RFID device 12 can be virtually any suitable device known to those in the RFID art. In the current embodiment, the device is passive, meaning that it does not include a power source but rather is powered by an electromagnetic field generated by the RFID reader. The current device 12 includes a nonconductive substrate or body 17, an antenna 14, and an RFID chip 16. The antenna 14 is formed on the substrate 17, and the chip 16 is attached both to the substrate and to the antenna. The shape and the size of the antenna are selected based on the radio frequencies used to power and to communicate with the device. Optionally, multiple antennas (not shown) may be used to improve the operation of the RF system.

The RFID chip 16 (FIG. 4) is known to those skilled in the RFID art. The RFID chip 16 may be operatively couple to the antenna 14 using any suitable method, for example conductive adhesive.

Alternatively, the plastic body 17 may be molded around the RFID chip 16 and the antenna 14.

Currently, the device 12 is simply inserted into the cavity 18 in the lower grab bar 11 (FIG. 4). The relatively shapes of the items may be selected to provide a close fit, a keyed fit, or some other fit to fixedly support the device within the bar. Adhesive or other securing means may be used to secure the device within the bar. And foam or other cushioning or protective material might be injected or placed in the cavity 18 to further cushion or protect the device. Sealant 19 is placed into both ends of the lower grab bar 11 to seal the cavity 18, and thereby to protectively seal the device 12 within the lower grab bar.

In addition to enabling new carts to be RFID-enabled, the present invention enables existing non-RFID carts to be RFID-enabled simply by replacing the non-RFID lower grab bar with the RFID lower grab bar of the present invention. Typically, the lower grab bar replacement would be performed by the entity owning and/or servicing the cart. After the lower grab bar is replaced, the RFID information contained in the lower grab bar typically is stored in the billing system to uniquely associate the retrofitted cart with a customer or pick-up address.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the,” or “said,” is not to be construed as limiting the element to the singular.

The embodiments of the invention in which an exclusive property or privilege is claimed are defined as follows:

1. An RFID-enabled waste/recycling container comprising:
a container adapted to receive waste/recyclables;
a lower grab bar supported by said container; and
an RFID device supported by said lower grab bar.

2. The container of claim 1 wherein:
said lower grab bar defines a cavity; and
said RFID device in located within said cavity.

3. The container of claim 2 further comprising securing means for fixedly securing said RFID device within said lower grab bar.

4. The container of claim 2 wherein said securing means includes at least one of adhesive, foam, a cushioning material, and a protective material.

5. The container of claim 2 wherein:
said cavity extends the full length of said lower grab bar; and
said securing means includes sealing means for sealing at least one of the ends of said cavity.

6. An RFID-enabled waste/recycling container lower grab bar assembly comprising:
a lower grab bar;
an RFID device supported by said lower grab bar.

7. The RFID-enabled lower grab bar assembly of claim 6 wherein:
said lower grab bar defines a cavity; and
said RFID device is positioned within said cavity.

8. The RFID-enabled lower grab bar assembly of claim 7 further comprising securing means for fixedly securing said RFID device within said cavity.

9. The RFID-enabled lower grab bar assembly of claim 8 wherein said securing means includes at least one of adhesive, foam, a cushioning material, and a protective material.

10. The RFID-enabled lower grab bar assembly of claim 6 wherein said lower grab bar is a nonmetallic material.

11. The RFID-enabled lower grab bar assembly of claim 7:
wherein said lower grab bar includes a pair of opposite ends and said cavity opens through at least one of said ends; and
further comprising a sealant within said at least one end and adapted to seal said RFID device within said cavity.

12. A method of retrofitting a waste/recycling container to provide RFID capability, said method comprising the steps of:
removing a non-RFID-enabled lower grab bar from the container; and
installing an RFID-enabled lower grab bar on said container.

13. The method of claim 12 wherein:
said removing step includes withdrawing the non-RFID-enabled lower grab bar from holes in the container; and
said installing step includes inserting the RFID eanbled lower grab bar into the holes.
